(19) United States
(12) Patent Application Publication
(10) Pub. No.: US 2008/0275653 A1
(43) Pub. Date: Nov. 6, 2008

(54) Microscale Flash Separation of Fluid Mixtures

(75) Inventors: Stephen Cypes, San Jose, CA (US); Sam H. Bergh, San Mateo, CA (US); Damian Hajduk, San Jose, CA (US)

Correspondence Address: SENNIGER POWERS LLP (SMX), 100 NORTH BROADWAY, 17TH FLOOR, ST. LOUIS, MO, 63102, US

(73) Assignee: SYMYX TECHNOLOGIES, INC., Sunnyvale, CA (US)

(21) Appl. No.: 12/066,996

(22) PCT Filed: Sep. 14, 2006
(86) PCT No.: PCT/US06/35873

§ 371 Date: Jun. 20, 2008

Related U.S. Application Data
(60) Provisional application No. 60/717,354, filed on Sep. 14, 2005.
(60) Provisional application No. 60/794,958, filed on Apr. 26, 2006.

(51) Int. Cl. G01N 31/00; B01D 17/12; B01D 3/06

(52) U.S. Cl. 702/24; 210/540; 210/255; 210/195.1; 210/239; 203/88

(57) ABSTRACT

Systems, methods and apparatus implementing techniques for separating and/or analyzing fluid mixtures. The techniques employ microfluidic separation devices that include an inlet port for receiving a fluid feed stream, a microscale fluid flow channel in fluid communication with the fluid inlet port, a phase equilibrium control region located along the fluid flow channel for controlling conditions including temperature and/or pressure to provide a thermal equilibrium, a capillary network in the temperature control region, a first outlet port in indirect fluid communication with the fluid flow channel through the capillary network, and a second outlet port in direct fluid communication with the fluid flow channel. A plurality of microfluidic separation devices can be coupled in fluidic communication to provide for separation of complex mixtures. The systems, methods and apparatus can be used to characterize fluid mixtures.

### CROSS-REFERENCE TO RELATED APPLICATIONS

This application is related to U.S. Provisional Application No. 60/717,354, filed Sep. 14, 2005, and U.S. Provisional Application No. 60/794,958, filed Apr. 26, 2006, which are incorporated by reference herein.

### BACKGROUND

This invention relates to techniques for separating and analyzing fluid mixtures.

A number of industries depend on the ability to separate and/or characterize complex mixtures. Distillation is a common technique that used for these purposes. A number of established techniques exist to model typical distillation procedures on a smaller scale, including ASTM D86 distillations, ASTM D2892/5236 15-theoretical plate and vacuum pot-still distillations, and gas chromatography “simulated distillation” (“SimDis”) techniques. These techniques typically require large amounts of sample and/or equipment, long run times, multiple inputs, and/or extensive maintenance procedures, and can be of limited use for some mixtures due to excessive exposure of the sample to elevated temperatures at which thermal cracking can occur. Accordingly, there is a need for methods and apparatus that can be used to separate and/or characterize complex mixtures on a microfluidic scale.

### SUMMARY

The invention provides methods and apparatus implementing techniques for separating and/or analyzing complex fluid mixtures. In general, in one aspect, the invention features a microfluidic separation device and a microfluidic separation system for separating and/or analyzing fluid mixtures. The device includes an inlet port for receiving a fluid feed stream, a microscale fluid flow channel in fluid communication with the fluid inlet port, a phase equilibrium control region located along at least a portion of the fluid flow channel for providing a thermal equilibrium in the at least a portion of the fluid flow channel, a capillary network in the phase equilibrium control region, a first outlet port in indirect fluid communication with the fluid flow channel through the capillary network, and a second outlet port in direct fluid communication with the fluid flow channel. The capillary network is in fluid communication with the fluid flow channel and includes a plurality of capillary channels extending outwardly from an axis of the fluid flow channel. The fluid flow channel extending from the fluid inlet port to the second fluid outlet port.

Particular embodiments can include one or more of the following features. The capillary channels of the capillary network can be formed in one or more of a top, a bottom, or side surfaces of the fluid flow channel in the temperature control region. The capillary network can include at least 50, or at least 100,000 capillary channels. The fluid flow channel and the capillary network can be formed from the same material.

A microfluidic separation system can include a plurality of devices, as described above, in combination with fluid conduits that define a fluid flow path between the devices. The fluid conduits connect the plurality of devices in fluid communication to define a series of devices, such that the second outlet port of a first device in the series is in fluid communication with the inlet port of a second device in the series. The first device can be configured to operate at thermal equilibrium at a first temperature and pressure, and each subsequent device in the series can be configured to operate at thermal equilibrium at a temperature and/or pressure different from the temperature and/or pressure of a preceding device in the series. For example, each subsequent device in the series can be configured to operate at thermal equilibrium at a temperature lower than the temperature and/or a pressure higher than the pressure of a preceding device in the series in embodiments involving flash vaporization separations. Conversely, in embodiments involving flash condensation separations, each subsequent device in the series can be configured to operate at thermal equilibrium at a temperature higher than the temperature and/or a pressure lower than the pressure of a preceding device in the series.

The first outlet port of the second device in the series can be in fluid communication with the inlet port of the first device in the series to provide for recirculation of at least a portion of a fraction produced in the second device to a separation being performed in the first device. The second outlet port of the second device can be in fluid communication with the inlet port of a third device in the series, and the first outlet port of the third device can be in fluid communication with the inlet port of the second device to provide for recirculation of at least a portion of a fraction produced in the third device to a separation being performed in the second device. The system can include one or more liquid mixers located in the flow path between the first and second devices and/or the second and third devices in the series. The liquid mixers can be operable to mix the at least a portion of the fraction produced in the second device with the fluid feed stream for the first device and/or to mix the at least a portion of the fraction produced in the third device with the fluid feed stream for the second device.

The system can be configured as an arrangement of modular units, in which each of the modular units contains one of the plurality of devices and one of the liquid mixers optionally is associated with the one of the plurality of devices in each of the modular units. The modular units can be arranged to define an arrangement comprising a plurality of unit series. Each unit series can include a plurality of separation devices coupled in series. A first one of the unit series can be configured to produce a first vapor fraction and a first liquid fraction. A second one of the unit series can be configured to receive the single liquid fraction produced by the first unit series as an input fluid stream and to produce a second vapor fraction and second liquid fraction. Each of the unit series after the first unit series can be configured to operate at a higher temperature and/or a lower pressure than the preceding unit series in the arrangement, or at a lower temperature and/or a higher pressure than the preceding unit series in the arrangement. The system can include a source vessel for providing a fluid mixture to be separated. The source vessel can be in fluid communication with the inlet port of a first one of the plurality of devices through the fluid conduits.

In general, in another aspect, the invention features a microfluidic separation system. The system includes a plurality of separation devices, fluid conduits defining a flow path between the plurality of separation devices, a first liquid mixer located in the flow path between the first and second devices, and a second liquid mixer located in the flow path between the second and third devices. Each of the separation devices includes an inlet port for receiving a fluid feed stream, a microscale fluid flow channel in fluid communication with the fluid inlet port, a phase equilibrium control region located along at least a portion of the fluid flow channel, a capillary network in the phase equilibrium control region, a first outlet port in indirect fluid communication with the fluid flow channel through the capillary network, and a second outlet port in direct fluid communication with the fluid flow channel. The capillary network is in fluid communication with the fluid flow channel and comprising a plurality of capillary channels extending outwardly from an axis of the fluid flow channel. The fluid flow channel extends from the fluid inlet port to the second fluid outlet port. The fluid conduits connect the plurality of separation devices in fluid communication to define a series of devices such that the second outlet port of a first device in the series is in fluid communication with the inlet port of a second device in the series and the second outlet port of the second device in the series is in fluid communication with the inlet port of a third device in the series. The first liquid mixer is in fluid communication with the first outlet port of the second device and is operable to mix at least a portion of a liquid fraction produced in the second device with the fluid feed stream for the first device. The second liquid mixer is in fluid communication with the first outlet port of the third device and is operable to mix at least a portion of a liquid fraction produced in the third device with the fluid feed stream for the second device.

Particular embodiments can include one or more of the following features. The system can include a liquid flow splitter located in the flow path between the first outlet port of the third device and the second liquid mixer. The liquid flow splitter is operable to split the liquid fraction produced in the third device to form a recirculation stream for transport to the second liquid mixer and a side stream for transport to a fraction collector. The system can include a liquid flow splitter located in the flow path downstream of the first outlet port of a last one of the plurality of devices along the flow path. The liquid flow splitter can be operable to split the liquid fraction produced in the last one of the plurality of devices to form a recirculation stream for transport to a liquid mixer associated with the fluid inlet port of the last one of the plurality of devices, and a collection stream for transport to a fraction collector. The system can include a source vessel for providing a fluid mixture to be separated. The source vessel can be in fluid communication with the inlet port of a first one of the plurality of devices through the fluid conduits. The first device can be configured to operate at thermal equilibrium at a first temperature and pressure, and each subsequent device in the series can be configured to operate at thermal equilibrium at a temperature lower than the temperature and/or a pressure higher than the pressure of a preceding device in the series. Alternatively, each subsequent device in the series can be configured to operate at thermal equilibrium at a temperature higher than the temperature and/or a pressure lower than the pressure of a preceding device in the series.

The system can be configured as a series of modular units. Each of the modular units can contain one of the liquid mixers and one of the plurality of separation devices located downstream of the one of the liquid mixers along the flow path. The modular units can be arranged to define an arrangement comprising a plurality of unit series. Each unit series can include a plurality of separation devices coupled in series. Each of the unit series in the arrangement can be configured to produce a vapor fraction and a liquid fraction. Each unit series after the first unit series in the arrangement can be configured to receive the liquid fraction produced by the preceding unit series as an input fluid stream and to operate at a higher temperature and/or a lower pressure than the preceding unit series in the arrangement. Alternatively each unit series after the first unit series in the arrangement can be configured to receive the liquid fraction produced by the preceding unit series as an input fluid stream and to operate at a lower temperature and/or a higher pressure than the preceding unit series in the arrangement.

In general, in another aspect, the invention features methods and systems implementing techniques for separating components of a fluid mixture. The techniques include providing a feed stream containing a fluid mixture that includes a plurality of components, introducing the feed stream into a first microscale fluid flow channel, exposing at least a portion of the first fluid flow channel to first temperature and pressure conditions to establish a thermodynamic equilibrium between a first vapor phase comprising a first component of the fluid mixture and a first liquid phase comprising a second component of the fluid mixture, and separating the first vapor phase and the first liquid phase at the first temperature and pressure conditions by driving the first liquid phase through a capillary network comprising a plurality of capillary channels extending outwardly from an axis of the first fluid flow channel to obtain a first vapor fraction comprising the first component and a first liquid fraction comprising the second component.

Particular embodiments can include one or more of the following features. The techniques can include condensing the first vapor fraction, and introducing the condensed first vapor fraction into a second microscale fluid flow channel, exposing at least a portion of the second fluid flow channel to second temperature and pressure conditions to establish a thermodynamic equilibrium between a second vapor phase that includes a third component of the fluid mixture and a second liquid phase that includes the first component of the fluid mixture, and separating the second vapor phase and the second liquid phase at the second temperature and pressure conditions by driving the second liquid phase through a capillary network comprising a plurality of capillary channels extending outwardly from an axis of the second fluid flow channel to obtain a second vapor fraction comprising the third component and a second liquid fraction comprising the first component. The techniques can include combining at least a portion of the second liquid fraction with the feed stream to form a first combined feed stream, introducing the first combined feed stream into the first microscale fluid flow channel, and repeating the exposing of the first fluid channel and the separating of the first vapor phase and the first liquid phase on the first combined feed stream at the first temperature and pressure conditions. Some or all of the second liquid fraction can be collected. The second liquid fraction can be analyzed to characterize the first component and/or the fluid mixture. Analyzing the second liquid fraction can include determining an amount of the second liquid fraction.

The techniques can include condensing the second vapor fraction, and introducing the condensed second vapor fraction into a third microscale fluid flow channel, exposing at least a portion of the third fluid flow channel to third temperature and pressure conditions to establish a thermodynamic equilibrium between a third vapor phase comprising a fourth component of the fluid mixture and a third liquid phase comprising the third component, and separating the third vapor phase and the third liquid phase at the third temperature and pressure conditions by using driving the third liquid phase through a capillary network comprising a plurality of capillary channels extending outwardly from an axis of the third fluid flow channel to obtain a third vapor fraction comprising the fourth component and a third liquid fraction comprising the third component. The techniques can include combining at least a portion of the third liquid fraction with the condensed first vapor fraction to form a second combined feed stream, introducing the second combined feed stream into the second microscale fluid flow channel, and repeating the exposing of the second fluid channel and the separating of the second vapor phase and the second liquid phase on the second combined feed stream at the second temperature and pressure conditions. Some or all of the third liquid fraction can be collected. The third liquid fraction can be analyzed to characterize the first component and/or the fluid mixture. Analyzing the third liquid fraction can include characterizing the fluid mixture based on amounts of the second liquid fraction and the third liquid fraction. The steps of introducing, heating and separating can be performed at a flow rate of the feed stream of at least one milliliter per minute.

In general, in still another aspect, the invention features methods and systems implementing techniques for analyzing a fluid mixture. The techniques include providing a feed stream containing a fluid mixture, introducing the feed stream into a microscale fluid flow channel, exposing at least a portion of the fluid flow channel to first temperature and pressure conditions over a first time interval to establish a vapor-liquid equilibrium mixture, separating the vapor-liquid equilibrium mixture at the first temperature and pressure conditions by driving a liquid phase of the vapor-liquid equilibrium mixture through a capillary network comprising a plurality of capillary channels extending outwardly from an axis of the first fluid flow channel to obtain a liquid fraction and a first vapor fraction, determining a percentage of the feed stream vaporized at the first temperature and pressure conditions, and characterizing the fluid mixture based at least in part on the determined percentage of the feed stream vaporized at the first temperature.

Particular embodiments can include one or more of the following feature. The techniques can include repeating the exposing, separating and determining on one or more second portions of the feed stream over one or more second time intervals to determine a percentage of the feed stream vaporized at each of one or more second temperature and pressure conditions based on amounts of one or more second vapor fractions obtained from the separating at each of the one or more second temperature and pressure conditions, and determining a percentage of the feed stream vaporized at the second temperature and pressure conditions. Characterizing the fluid mixture can include characterizing the fluid mixture based at least in part on the determined percentage of the feed stream vaporized at the first and second temperature and pressure conditions. Characterizing the fluid mixture can include generating an Equilibrium Flash Vaporization (EFV) curve describing a percentage of the feed stream vaporized as a function of flash temperature. The EFV curve can be used to generate a True Boiling Point (TBP) curve for the fluid mixture. The feed stream can be provided from a batch source of the fluid mixture. The characterizing can include generating an ASTM D86 curve for the fluid mixture.

In general, in another aspect, the invention features a system for analyzing a liquid mixture. The system includes a fluid inlet port for receiving a fluid feed stream that includes a fluid mixture, a microscale fluid flow channel in fluid communication with the fluid inlet port, a temperature controller configured to provide a temperature-controlled environment along at least a portion of the fluid flow channel, a capillary network in fluid communication with the fluid flow channel, a first outlet port in indirect fluid communication with the fluid flow channel through the capillary network, a second outlet port in direct fluid communication with the fluid flow channel, a sensor coupled to the first outlet port or the second outlet port, and a processor coupled to the sensor. The capillary network includes a plurality of capillary channels extending outwardly from an axis of the fluid flow channel. The fluid flow channel extends from the fluid inlet port to the second fluid outlet port. The sensor is operable to determine an amount of one or more vapor or liquid components obtained at the first or second outlet port over one or more specified time intervals. The processor is operable to receive from the sensor signals representing the determined amounts of the vapor or liquid components, and to generate information characterizing the fluid mixture based on the determined amounts.

Particular embodiments can include one or more of the following features. The capillary channels of the capillary network can be formed in one or more of a side surface, a top surface or a bottom surface of the fluid flow channel. The system can include a source vessel for providing the fluid mixture to be separated. The source vessel can be in fluid communication with the fluid inlet port. The processor can be operable to generate an Equilibrium Flash Vaporization (EFV) curve that describes a percentage of the feed stream vaporized as a function of flash temperature and/or to generate a True Boiling Point (TBP) curve for the fluid mixture based on the EFV curve. The processor can be operable to generate an ASTM D86 curve. The capillary network can include at least 50, or at least 100,000 capillary channels. The system can be operable at a flow rate of the feed stream of at least one milliliter per minute. The system can be operable to generate a TBP curve in less than one hour, or in less than one minute from the introduction of the feed stream into the fluid inlet port. The system can be capable of handheld operation. The system can be capable of operation with inputs consisting essentially of the fluid feed stream and electrical power.

The invention can be implemented to realize one or more of the following advantages, alone or in the various possible combinations. Microfluidic separation devices and methods can be used to model or perform continuous, semi-continuous, or batch separations, such as production of refinery fractions, on a very small scale. Miniaturization of separation processes can lead to better, real-time characterization (including impact assessment) of refinery feedstocks and other complex mixtures. Use of the microfluidic separation devices and methods on refinery feedstocks can facilitate the exploitation of lower cost disadvantaged feedstocks, resulting in more efficient trading and placement of available crude resources, as well as safer, more reliable and efficient use of refinery assets.

Microfluidic flash separation devices, and systems incorporating such devices, can be configured with relatively small internal volumes, meaning that residence times in the device for the material being separated are low, which minimizes the amount of time the material is exposed to elevated temperatures during some procedures. Microfluidic flash separation devices, and systems incorporating such devices may be amenable to a high level of automation and parallelization. Microfluidic flash separation devices, and systems incorporating such devices, can provide for the collection of high-quality fractions with minimal mechanical complexity. The use of microfluidic separation devices in continuous fractionation configurations allows for the simultaneous collection of multiple fractions plus residue.

Microfluidic flash separation devices as described herein can be incorporated into a fluid analyzer that is capable of generating a True Boiling Point curve for complex mixtures. The microfluidic TBP analyzer has a small internal volume, and is therefore capable of producing a TBP curve with relatively small amounts of input material. The microfluidic TBP analyzer can produce a TBP curve in less time, and with less required maintenance, than currently available alternatives. The microfluidic TBP analyzer can be configured to generate a TBP curve for a mixture with only the mixture itself and electricity as inputs. In some configurations, the microfluidic TBP analyzer can be completely portable.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram generally illustrating a microfluidic separation device according to one aspect of the invention.

FIG. 2 is a flow diagram illustrating a method of separating a mixture using flash vaporization according to one aspect of the invention.

FIGS. 3A-3E illustrate one embodiment of a MEMS method for fabricating the microfluidic separation device shown in FIG. 1.

FIG. 4 illustrates a capillary network comprising a two-dimensional matrix of capillary channels according to one aspect of the invention.

FIGS. 5A-5C are schematic diagrams illustrating one embodiment of a microfluidic separation device according to FIG. 1.

FIG. 6 is a schematic diagram illustrating one embodiment of a separation system incorporating a microfluidic separation device according to FIG. 1.

FIG. 7 is a schematic diagram illustrating one embodiment of a multi-stage separation system incorporating a plurality of microfluidic separation devices.

FIG. 8 is a schematic diagram illustrating an alternative embodiment of a multi-stage separation process and system incorporating a plurality of microfluidic separation devices.

FIG. 9 is a schematic diagram illustrating still another embodiment of a multi-stage separation process and system, incorporating a plurality of liquid mixers, flow splitters and microfluidic separation devices.

FIG. 10 is a schematic diagram illustrating one embodiment of a modular single-stage flash separation unit according to one aspect of the invention

FIG. 11 is a schematic diagram illustrating a modular multi-stage flash separation system comprising an arrangement of multiple flash separation units.

FIG. 12 is a schematic diagram illustrating one embodiment of a six-stage separation process and system that can be implemented using the modular system of FIG. 11.

FIG. 13 is a schematic diagram illustrating one embodiment of a multi-stage batch separation process and system according to one aspect of the invention.

FIG. 14 is a flow diagram illustrating a method for characterizing a multi-component mixture using a microfluidic separation device according to one aspect of the present invention.

FIG. 15 is a schematic diagram illustrating a single-stage separation process and system suitable for use in characterizing fluid mixtures.

Like reference symbols in the various drawings indicate like elements.

### DETAILED DESCRIPTION

The invention provides methods and apparatus for separating fluid mixtures using microscale separations, and, more specifically, microscale flash separations, such as equilibrium flash vaporization (“EFV”). In general, the separation techniques described herein involve the exposure of a fluid (e.g., liquid or gas) mixture to conditions, including temperature and pressure, that cause the feed mixture to enter a state above its bubble point and below its dew point, such that vapor and liquid phases form. Thus, a flash vaporization occurs when a liquid feed, typically, although not necessarily at room temperature and atmospheric pressure, is heated (or subjected to reduced pressure) to bring the feed mixture to a point above the bubble-point of the mixture but below its dew-point, such that vapor and liquid phases form. Likewise, a flash condensation occurs when a gaseous feed is cooled (and/or subjected to elevated pressure) in order to bring the gaseous feed mixture to a point below its dew point and above its bubble point, again such that vapor and liquid phases form. In either case, vapor-liquid equilibria (i.e., thermodynamics) govern the way in which species separate into each phase, but generally the lighter molecules are enriched in the vapor, and the heavier molecules are enriched in the liquid. The following discussion focuses on embodiments involving the separation of mixtures by means of flash vaporization, although it should be understood that the methods, apparatus and systems described herein are equally applicable to separations employing flash condensation procedures.

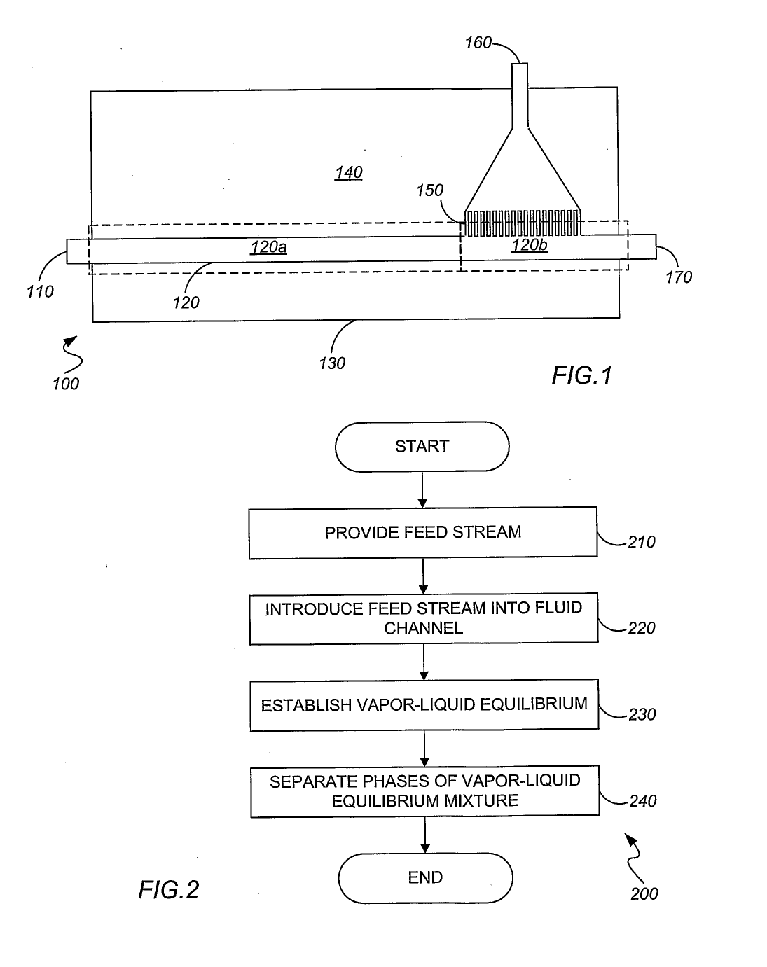

A general embodiment of a device 100 for performing flash vaporization separations according to one aspect of the invention is shown in FIG. 1. The device includes in inlet port 110 for introducing a fluid to be separated. The inlet port is in fluidic communication with a microscale fluid flow channel 120 located in a housing 130. Flow channel 120 extends through a phase equilibrium control region 140, in which device 100 can be operated to provide a thermal equilibrium at a selected or predetermined temperature and/or pressure. Flow channel 120 includes a thermal equilibrium zone 120a, in which a fluid passing through flow channel 120 is brought to thermal equilibrium, and a phase separation zone 120b. A capillary network 150 is located in phase equilibrium control region 130, in fluidic communication with phase separation zone 120b of flow channel 120. Capillary network 150 includes an arrangement of capillary channels that extend outwardly from an axis of flow channel 120 and communicate with an outlet port 160 that exits housing 130. A second outlet port 170 also exits housing 130, and is in direct fluid communication with flow channel 120.

The device 100 can be used to carry out flash separation operations upon fluids that are introduced into inlet port 110. A representative method 200 for carrying out such a flash separation operation using device 100 is illustrated in FIG. 2. According to method 200, a feed stream containing the fluid mixture to be separated is provided (step 210). The feed stream is introduced into fluid channel 120 through inlet port 110 (step 220). As the feed stream passes through flow channel 120, phase equilibrium region 140 is subjected to temperature and/or pressure control to obtain a temperature that is above the bubble point and below the dew point of the fluid mixture at the operating pressure of the device (step 230), resulting in the formation in flow channel 120 of a gas phase and a liquid phase in thermal equilibrium in thermal equilibrium zone 120a. As the fluid passes into phase separation zone 120b, the phases are separated under the operating conditions by driving the liquid phase portion through the pre-wet capillary channels of capillary network 150 (i.e., co-current flow) using pressure-driven flow (where the pressure is high enough to drive the liquid phase through the pre-wet capillary channels but low enough that the vapor phase cannot overcome the capillary pressure), with the gas phase portion continuing through flow channel 120 to outlet port 170 (step 240). A liquid fraction that is enriched in the higher-boiling components of the starting fluid mixture can be collected at outlet port 160, while a vapor fraction that is enriched in lower-boiling components of the starting mixture can be collected (optionally, after condensation) at outlet port 170. Optionally, one or both of the fractions can be subjected to additional processing operations, as will be discussed in more detail below.

As used in this specification, a fluid is a material that is a liquid, gas, or liquid-gas mixture when it is introduced into the device, and specifically includes materials that may exist in a solid or semi-solid form under ambient conditions (i.e., materials that may be solids or semi-solids at ambient conditions, but that may be liquids, gasses, or mixtures thereof when introduced into the device at elevated temperatures or reduced pressures. Exemplary fluid mixtures to which the methods and apparatus described herein can be applied include, without limitation, petroleum products (such as crude oils or crude oil fractions), agricultural products (such as plant oils, distillates and extracts), animal oils, wines and spirits, flavors, fragrances, and the like.

In general, the feed stream can be introduced using any convenient technique, including pumping, injection, or other conventional methods, at flow rates typically in the range from about 0.1 ml/min to about 5 ml/min (although higher and lower flow rates are possible). In some embodiments, flow rates of about 1 ml/min are preferred. Inlet port 110 can take any convenient form, including, for example, valves, septa, or other components capable of withstanding the introduction of the feed stream under pressure.

As noted above, flow channel 120 is a “microscale” channel, which in the context of this specification, means that the channel has cross-sectional dimensions smaller than about 5,000 microns—for example, in the range from about 1 micron to about 1000 microns. The flow channel is typically formed with a square or rectangular cross-section, although flow channels having any desired cross-sectional shape can be used; typically, the shape of the flow channel will be determined to some extent by the techniques used to fabricate the device, one example of which is discussed in more detail below. The flow channel can be any desired length, provided that pressure drop along its length remains within the operating parameters of the device. In typical embodiments, the microscale flow channel may be between 5 and 200 cm in length, with longer flow channels being desirable to provide for longer residence times during which to establish thermal equilibrium. In some embodiments, illustrated in more detail below, flow channel 120 can be configured to define a serpentine or other tortuous path to increase the amount of time during which the fluid mixture is exposed to the thermal equilibrium and therefore increase the size of the volume of flow channel 120 in which flash separation can occur.

All or just a portion of fluid flow channel 120 can be located within phase equilibrium control region 140, such that a thermal equilibrium can be established along at least a portion of the length of flow channel 120. In this region, the fluid mixture is exposed to controlled temperature and/or pressure conditions, which as used in this specification, includes controlling either the temperature or pressure in region 140 while maintaining the other constant (e.g., at ambient temperature or atmospheric pressure), as well as controlling both temperature and pressure in region 140. Temperature and/or pressure control (i.e., heating and/or cooling, vacuum and/or pressurization) can be provided externally, such as by an external temperature controller and heater (e.g., Watlow MLS 300 with Type K thermocouple feedback) or by placement of device 100 in an oven or refrigerator. Alternatively, device 100 can be configured to provide on-chip heating (e.g., resistance heaters and resistance temperature detectors). In some embodiments, device 100 can be configured to provide for an isothermal (and/or isobaric) environment throughout housing 130 (such that phase equilibrium control region 140 corresponds to the interior of housing 130). Alternatively, temperature and/or pressure control can be applied to a portion of the interior of housing 130, with phase equilibrium control region 140 corresponding to the temperature/pressure-controlled portion only. As noted above, the device can be operated at atmospheric pressure, at reduced pressure, or at elevated pressure, depending on the particular application. Operation at reduced pressure makes it possible to separate high boiling materials without experiencing thermal decomposition (e.g., cracking) that may occur at high temperatures.

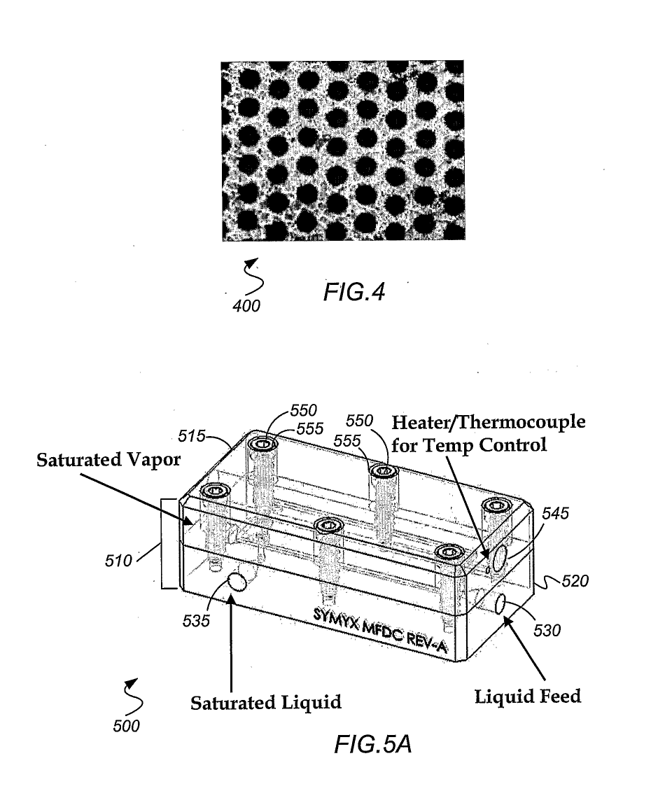

Capillary network 150 includes a collection of capillary channels that form a porous structure in which the liquid phase can be separated from the vapor phase. The efficiency of the phase separation is governed by the size and number of the capillary channels, the total volumetric flow rate of gas and liquid in the device, the surface tension of the liquid phase, the contact angle of the liquid phase on the walls of flow channel 120, and the absolute pressures on each side of capillary network 150. Typically, the capillary channels are between 1 and 500 microns in hydraulic diameter and at least 10 microns long (limited on the smaller end by capabilities of available microfabrication processes), although the capillary channels may be configured in any desired dimensions so long as the channels are small enough that capillary pressure blocks the passage of the gas phase through the (pre-wet) capillary channels during operation, while the liquid phase is able to flow through the capillary channels by pressure-driven flow. The capillary network should include a sufficient number of capillary channels, having a small enough diameter, that the pressure drop across the capillary network is large enough to drive all of the liquid phase through the capillary channels, but is smaller than the capillary pressure (defined by the capillary channel diameter, and the surface tension and contact angle of the liquid). In particular embodiments, the capillary network can include as few as two capillary channels and as many as one million or more capillary channels, depending on the particular application and fabrication techniques. Some embodiments feature at least 50, at least 100, at least 1,000, at least 50,000, at least 250,000, or at least 500,000 capillary channels. The capillary channels can be formed on top, bottom or sides of flow channel 120. In some embodiments, the network of capillary channels can be fabricated as a linear array of channels along flow channel 120; alternatively, the capillary network can be formed as a two-dimensional matrix of channels 400, as illustrated in FIG. 4.

The capillary channels of capillary network 150 can be formed by the same material as flow channel 120, or by one or more different materials, and can be formed as discrete, separate channels (e.g., a network of parallel channels as shown in FIG. 1) or as a network of interconnected channels (e.g., pores). Thus, in one embodiment, discussed below, flow channel 120 and capillary network 150 are formed by micromachining parallel channels from a monolithic material. Alternatively, capillary network 150 can be provided as one or more porous frits, membranes, or packed media.

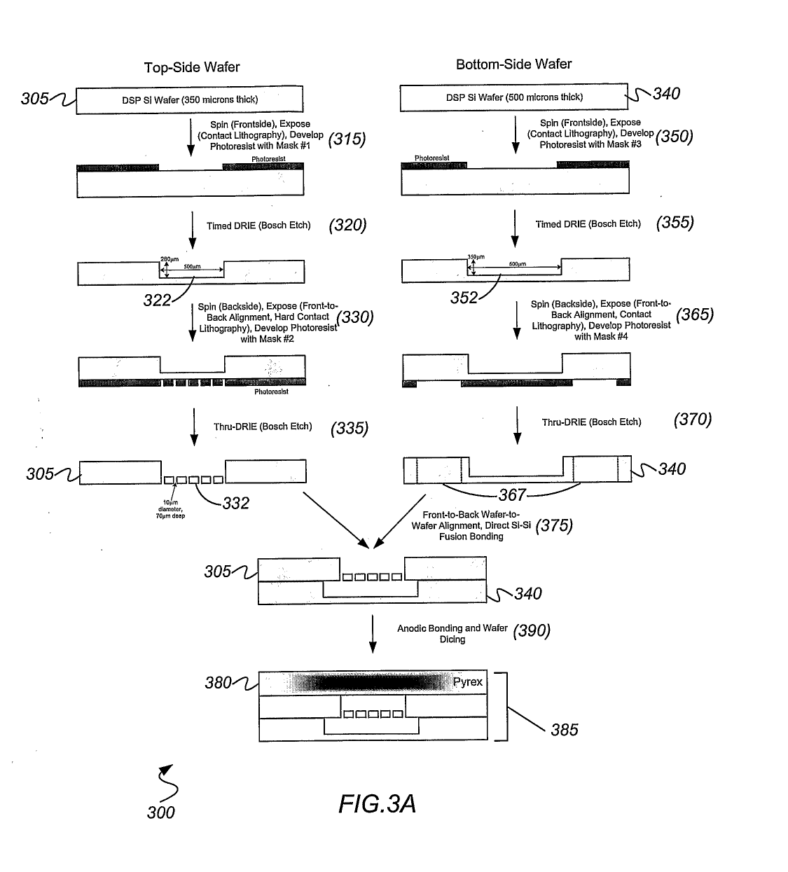

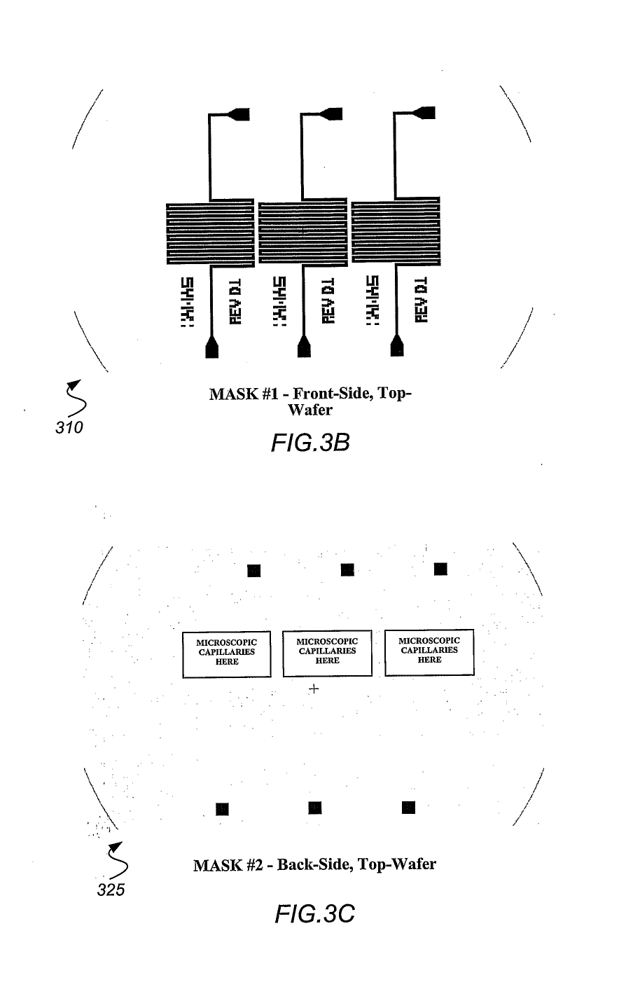

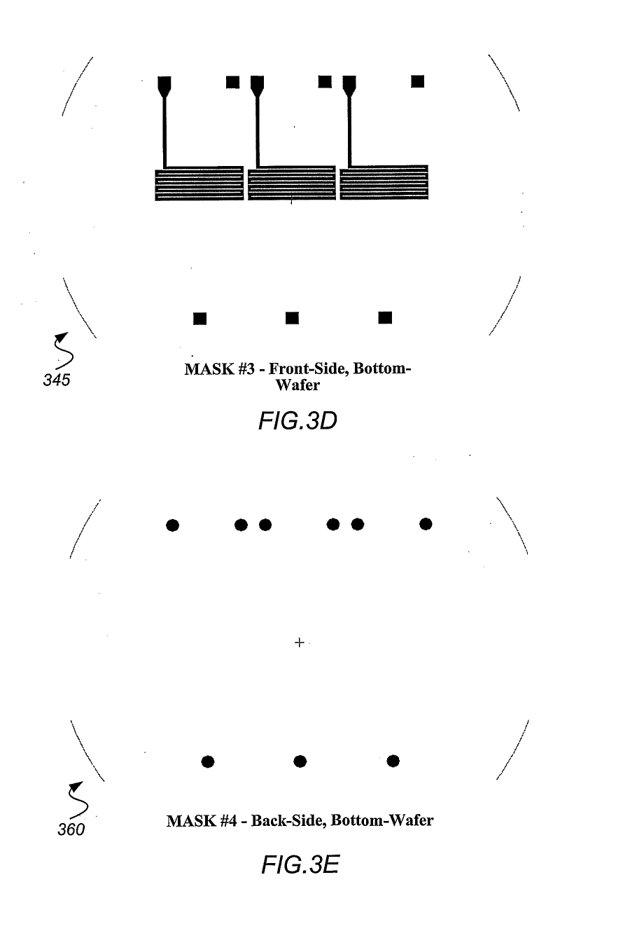

Device 100 and its various components can be fabricated using conventional techniques from any material that can be micromachined using conventional techniques, including alloys, silicon, quartz, glass and pyrex—preferably, materials that are inert to the expected components of the fluid feed stream. In the embodiment mentioned above, the flow channel and capillary network are fabricated using the four-mask technique 300 illustrated in FIG. 3A. According to method 300, a top wafer is prepared by spin-coating the front-side of a 350 micron-thick DSP silicon wafer 305 with photoresist, followed by exposure using contact lithography and development using a first mask 310 (FIG. 3B) (step 315). Timed deep reactive ion etching (DRIE) of the front-side substrate is performed (step 320) to obtain a channel 322 that is 500 microns wide and 280 microns deep. Wafer 305 is then subjected to back-side spin-coating with photoresist, exposed in front-to-back alignment using hard contact lithography, and the photoresist is developed using a second mask 325 (FIG. 3C) (step 330). Back-side thru-DRIE then produces a network 332 of 10μ×70μ capillary channels (step 335).

A bottom wafer is prepared by spin-coating the front-side of a 500 micron-thick DSP silicon wafer 340 with photoresist, followed by exposure using contact lithography and development using a first mask 345 (FIG. 3D) (step 350). Timed front-side DRIE produces a channel 352 that is 600 microns wide and 350 microns deep (step 355). Wafer 340 is then subjected to back-side spin-coating with photoresist, exposed in front-to-back alignment using contact lithography, and the photoresist is developed using a fourth mask 360 (FIG. 3E) (step 365). Back-side thru-DRIE then produces through-holes 367, which provide the necessary fluid inlets and outlets for the device (step 370). Wafers 305 and 340 are then aligned and bonded using direct Si—Si fusion bonding (step 375). A pyrex sheet is bonded to the front-side of wafer 305 using anodic bonding, and (assuming the starting wafers 305, 340 are large enough to yield multiple chips) the bonded wafers are diced to yield multiple flash separation chips 385 (step 390).

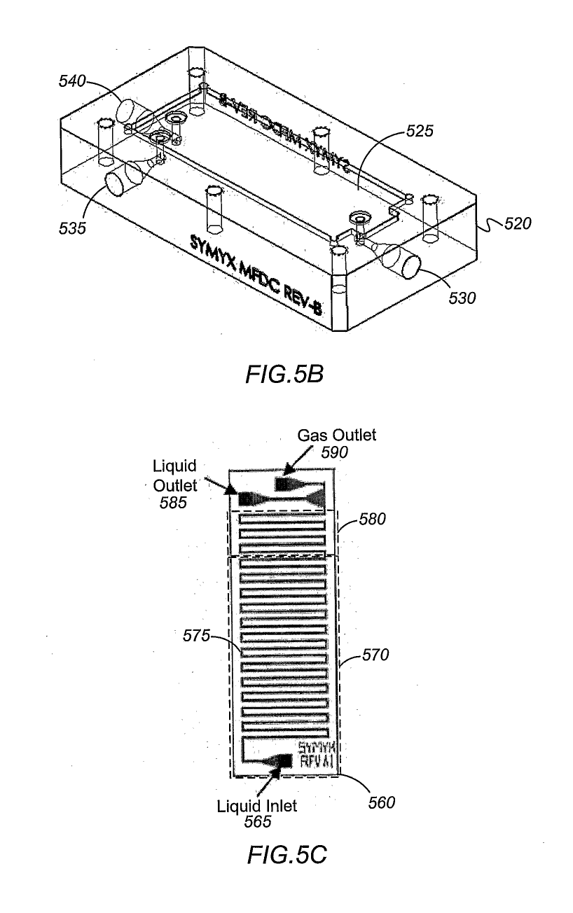

FIG. 5A illustrates a particular embodiment of a device 500 that incorporates a chip 560 (FIG. 5C). Housing 510 includes a top plate 515 and a bottom plate 520 fabricated from stainless steel (or other appropriate material). As shown in more detail in FIG. 5B, bottom plate 520 includes a central cavity 525, which is sized and shaped to receive chip 560. Inlet port 530 is configured to receive an input feed stream and to deliver the feed stream to liquid inlet 565 and phase equilibrium zone 570 of flow channel 575 (FIG. 5C). Liquid outlet port 535 is configured to receive a saturated liquid fraction separated in a capillary network located at the bottom of flow channel 575 in phase-separation zone 580 via liquid outlet 585 (note that liquid outlet 585 and the channel connecting it to flow channel 575 are formed in a lower layer than the other illustrated features of chip 560), while vapor outlet port 540 (FIG. 5B) is configured to receive the saturated vapor fraction that remains at gas outlet 590 of flow channel 575. Top plate 515 also includes a port 545 for connection of a thermocouple and heater to provide for external control of the temperature within housing 510. When chip 560 has been placed into cavity 525, top plate 515 and bottom plate 520 can be secured together by means of fasteners 550 (e.g., screws and springs) inserted into through-holes 555.

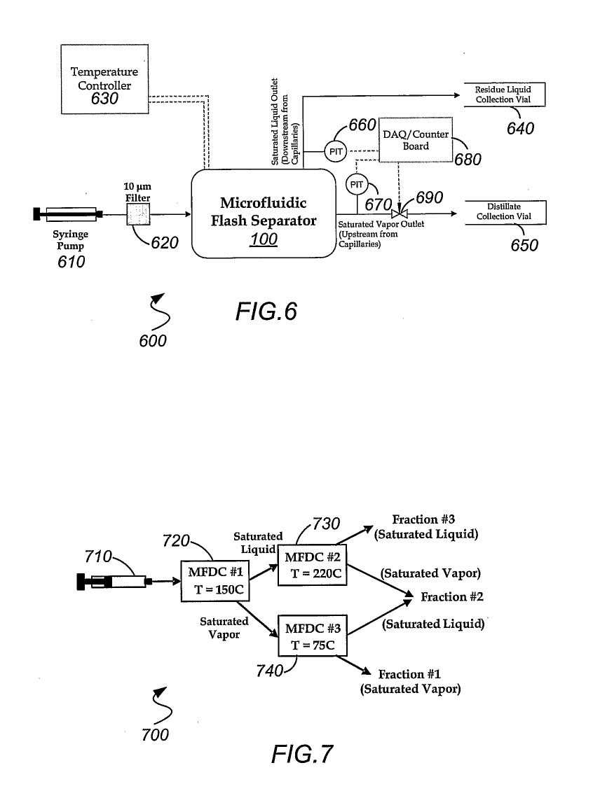

In one embodiment, a microfluidic flash separation device 100 can be incorporated into a flash vaporization system 600, illustrated in FIG. 6. The fluid mixture to be separated is introduced into the inlet port of separator 100 from source 610, such as a syringe pump charged with the fluid mixture, optionally after passing through filter 620 to remove any particulate material. The mixture is heated to the selected flash temperature in phase equilibrium control region 140 (FIG. 1) under the control of temperature controller 630. The liquid fraction is separated in capillary network 150 and is collected in liquid collection vial 640, while the vapor fraction is condensed and collected in distillate collection vial 650. It should be noted that system 600 can be used to perform flash condensation separations by cooling, instead of heating, the fluid mixture (in this case, preferably a gaseous mixture) in phase equilibrium control region 140 to generate a liquid phase. Likewise, flash vaporization and/or condensation separations can be performed by controlling pressure instead of, or in addition to, temperature in phase equilibrium control region as also discussed above.

Active flow control is provided to ensure that the pressure drop across the capillary network is maintained within the device's operating window. In this embodiment, flow control is provided by a combination of pressure transducers 660, 670, and valve 690, which operate under the control of processor 680 to ensure that the pressure drop over the capillary network is maintained in the range 0 to 1 psid at all flow conditions. The particular components selected to provide flow control are not critical to the invention. Particular examples include two 0-5 psig pressure transducers (Omega Engineering) coupled to one of (1) a low-dead volume on-off solenoid valve (Lee Company) operating at ˜2 Hz, with on-off control implemented via a digital line through a relay; (2) a low-dead volume PWM solenoid valve (Lee Company) operating at 20 Hz, with PWM implemented via a counter on DAQ board through a relay; or (3) a proportional solenoid valve (Parker Pneutronics, packaged within pressure controller from Alicat Scientific) with setpoints realized via an analog output.

In another aspect of the invention, a plurality of the above-described flash separation devices are combined in fluidic communication to provide for multi-stage separation procedures that can be useful in the separation of complex mixtures. A general schematic of one such multi-stage separation system 700 is shown in FIG. 7. As shown, system 700 includes a source of the fluid mixture, such as a syringe pump 710, which introduces the fluid feed into a first separation device 720. The saturated liquid fraction isolated in device 720 is fed into a second device 730, and the saturated vapor fraction is fed into a third device 740. In the example shown, device 720 is operated at a temperature of 150° C. to effect the initial separation, while the resulting liquid fraction is further separated at 220° C. in device 730 and the vapor fraction is separated at 75° C. in device 740 (alternatively, the devices can be operated at successively lower pressures to perform an analogous flash vaporization, or conversely at successively lower temperatures/higher pressures to perform a flash condensation). Three fractions are collected from this separation—a light (vapor) fraction resulting from the low temperature separation in device 740 (Fraction #1), a middle fraction representing the combined liquid fraction from device 740 and vapor fraction from device 730, and a heavy (liquid) fraction resulting from the high temperature separation in device 730.

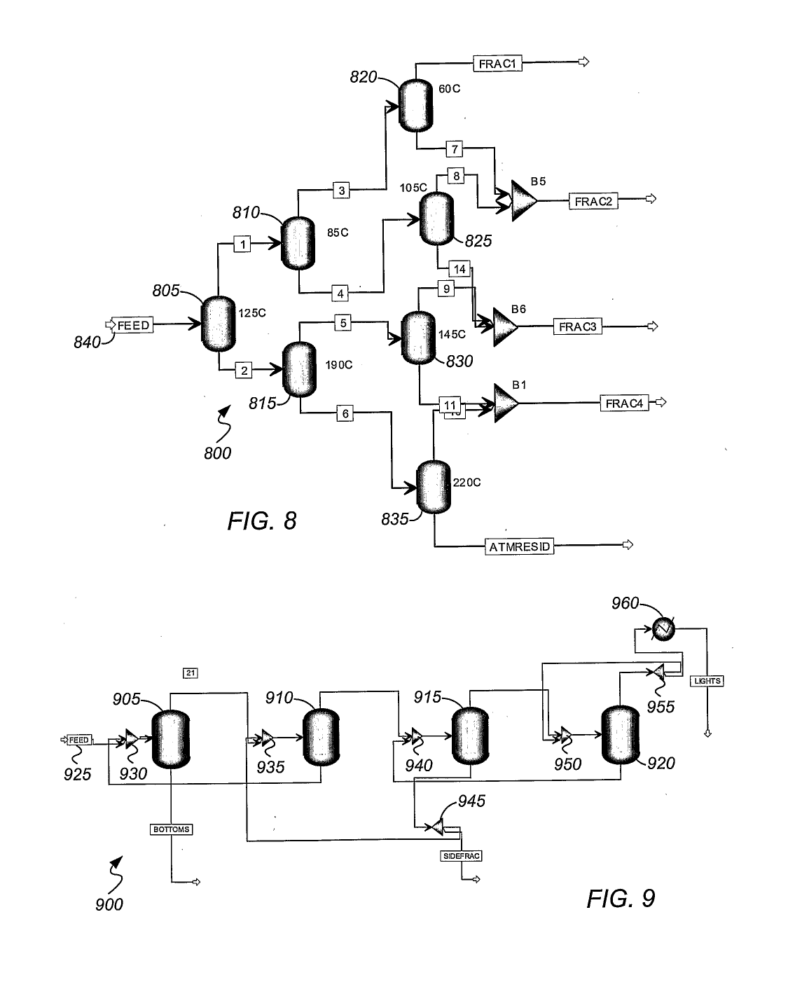

In some embodiments, such multi-device systems can be used to model distillation processes, such as a refinery crude fractionation. In these embodiments, the flow of each stream is modeled as it would occur in a crude fractionation column, with each column tray being modeled as a flash separation. The temperature of each separation is set by the predicted temperature for the corresponding tray (as determined using, e.g., commercially available simulation software). A particular example is shown in FIG. 8, in which a system 800 of seven microfluidic flash separators 805, 810, 815, 820, 825, 830 and 835 is used to collect five fractions (representing a total of 8 separation streams) from an input feed.

To provide for more effective separations and to more accurately model distillation processes, such systems can incorporate a series of mixers and flow splitters to provide for recycling and recombination of a portion of the liquid fraction obtained in one or more stages of a multi-stage separation. One such system is illustrated in FIG. 9. As shown, a multi-stage separation system 900 includes four flash separation devices 905, 910, 915, 920, coupled in series so that the light fraction obtained in each device is used as a portion of the input feed for the next device in the series. In operation, an input feed 925 is continuously introduced into device 905 through mixer 930, which combines the input feed with some or all of the heavy fraction obtained from the second device 910 as will be described in more detail below. As shown in FIG. 9, mixer 930 (and mixers 935, 940 and 950) provides both mixing and pumping functionality to pump the fluid feed stream at a desired rate and pressure. In specific embodiments, the mixing and pumping capabilities of mixers 930, 935, 940, 950 can be provided in a series of integral mixer/pump units, or as separate mixing and pumping devices in fluid communication.

The separation in device 905 proceeds at a first temperature, yielding a heavy (“bottoms”) fraction (which can be collected and/or subjected to further processing as desired—for example, one or more additional flash vaporization separations an another system 900 operating at reduced pressure) and a light fraction that is condensed and transported device 910 through a second mixer 935 (which combines this fraction with at least a portion of the heavy fraction produced in device 915). In device 910, this feed is separated at a second temperature (e.g., a temperature lower than the operating temperature of device 905). As noted above, the heavy fraction produced in this separation is recirculated to mixer 930, where it is combined with the original input feed and subjected to an additional separation in device 905.

The light fraction produced in device 910 is condensed and transported to device 915 through a third mixer 940, which can combine this fraction with some or all of the heavy fraction produced in device 920. This feed is separated at a third temperature (e.g., a temperature lower than the operating temperature of device 910) in device 915. The heavy fraction produced in this separation is transported to flow splitter 945. Flow splitter 945 can be configured to direct some, all (or none) of the heavy fraction produced in device 915 to mixer 935, where it is combined with the light fraction from device 905 and subjected to an additional separation in device 910. Any remaining portion of the heavy fraction produced in device 915 can be collected as a side fraction and, optionally, subjected to additional processing. In some embodiments, flow splitter 945 can be a variable flow splitter that is configurable by a user to provide for recirculating varying amounts of material depending on the conditions of the particular separation being performed.

The light fraction produced in device 915 is condensed and transported to device 920 through a fourth mixer 950, which combines this fraction with some or all (or none) of the light fraction produced in device 920. This feed is separated at a fourth temperature (e.g., a temperature lower than the operating temperature of device 915) in device 920. The heavy fraction produced in this separation is transported to mixer 940, where it is combined with the light fraction from device 910 and subjected to an additional separation in device 915. The light fraction produced in device 920 is transported to flow splitter 945, which can be can be configured to direct some, all (or none) of the light fraction produced in device 920 to mixer 940, where it is combined with the light fraction produced in device 915 and subjected to an additional separation in device 920. Any remaining portion of the light fraction produced in device 920 is condensed in condenser 960 and collected as a light (distillate) fraction and, optionally, subjected to additional processing. In some embodiments, flow splitter 955 can be a variable flow splitter that is configurable by a user to provide for recirculating varying amounts of material depending on the conditions of the particular separation being performed.

As noted above, the use of mixers and flow splitters in system 900 provides for the recirculation and recombination of various feed streams in a manner analogous to reflux conditions obtained in a typical distillation column, which results in an enrichment of more volatile components in the light streams produced streams produced in each of the flash separation stages and of less volatile components in the corresponding heavy streams. Although the embodiment shown in FIG. 9 includes only two flow splitters 945 and 955, in other embodiments additional flow splitters may be included in other lines—for example, in the line transporting the heavy fraction from device 910 to mixer 930 or the line transporting the heavy fraction from device 920 to mixer 940—which may permit the collection of one or more additional side fractions. Optionally, additional components can be added to the system to provide additional functionality—for example, mass flow meters can be provided to quantify the streams produced in one or more of the separations. In this or any other embodiment, the system can be operated at atmospheric pressure, reduced pressure or elevated pressure, as noted above. In embodiments operating at reduced pressure (e.g., separation of a heavy gas oil fraction (typical boiling range of 509° C. to 550° C. at atmospheric pressure) from a vacuum residue fraction of a crude oil feedstock), vacuum can be pulled at any convenient point in the system—for example, where one or more fractions are collected, or at one or more of mixers mixer 930, 935, 940 or 950 in FIG. 9.

More generally, embodiments of the present invention can be implemented as combinations of modular components by coupling one or more microscale flash separation devices as described above, with one or more small-scale pumps, pressure transducers, control valves, level sensors, liquid mixers and/or microfluidic mass flow meters to form a single- or multi-stage fractionation system that may be amenable to use in a high-throughput automated workflow.

In particular embodiments, such systems can be conveniently assembled as combinations of three modules: a flash separator module, a liquid mixer module, and a flow splitter module. The flash separator module performs the flash separation as described above, and is capable of operation at temperatures up to 400° C. and pressures down to 10 torr, with active pressure control across the capillary network provided by low internal volume control valves and low dead-volume pressure transducers, as described above. The liquid mixer module is responsible for combining feed streams and controlling the pressure drop at each stage of the system, and incorporates a liquid mixer, a micropump capable of delivering fluid from the liquid mixer to the flash separator at controlled flowrates and head pressures, a liquid level sensor to sense high and low liquid levels in the liquid mixer, and a vent (or controlled vacuum) from the headspace of the liquid mixer, such that system pressure drop will only be the pressure drop over a single tray. The flow splitter module is responsible for splitting the fluid stream as discussed above and quantifying the yield structure of the separation, and incorporates one or two microfluidic mass flow meters for measuring flowrates, and a control valve for liquid flow splitting.

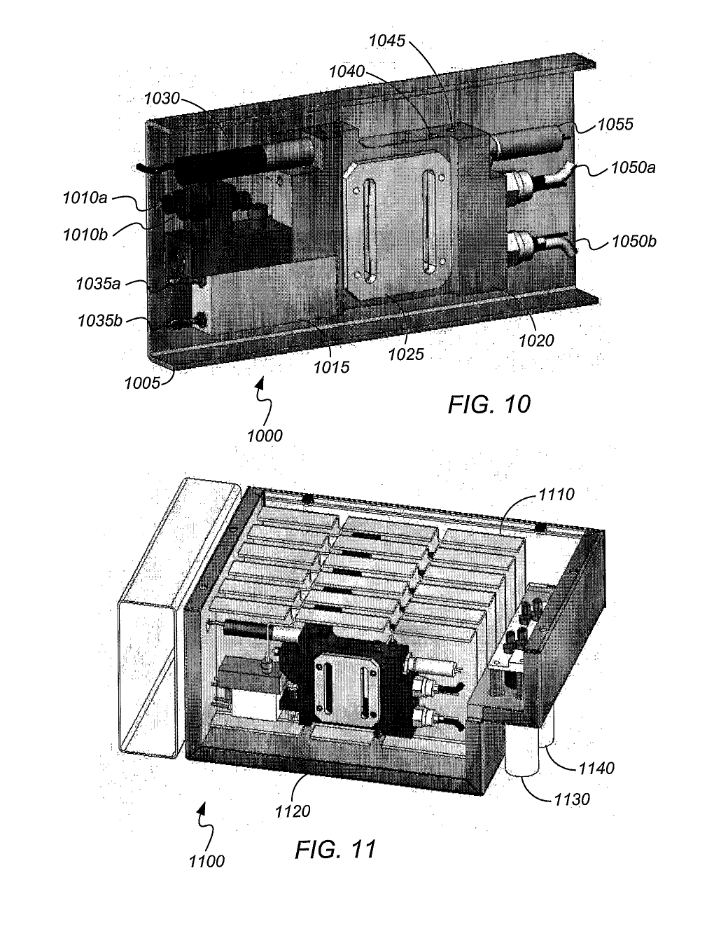

In one embodiment, a flash separator module, liquid mixer module and flow splitter module can be combined to form an integrated “tray” 1000 as shown in FIG. 10. The fluid mixture to be separated is introduced at a first inlet 1010a, and enters liquid mixer 1015, where it is optionally mixed with another fluid stream (such as a recirculation stream from a subsequent separation as discussed above) received through a second inlet 1010b. The (optionally mixed) fluid stream is then transported to the microfluidic separation device (not shown), which is located in thermal block 1020 behind insulation clamp 1025, under the control of micropump 1030. High and low level sensors 1035a and 1035b, respectively, monitor the level of the fluid stream in liquid mixer 1015 to ensure that micropump 1030 does not run dry. The fluid stream is separated in the microfluidic separation device as described above, and the separated liquid phase emerges at liquid outlet 1040, while the vapor phase emerges (optionally in condensed form depending on the configuration of the microfluidic separation device and/or block 1020) at vapor outlet 1045, and the separated phases are transported for further processing through flow conduits (and optional flow meters) (not shown). The pressure drop across the capillary network of the microfluidic separation device is controlled by pressure transducers 1050a and 1050b (one for each of the vapor and liquid side of the capillary network; alternatively, a single differential pressure transducer can be used) and back-pressure control valve 1055. These components are optionally configured as a self-contained unit within a housing 1005 as shown.

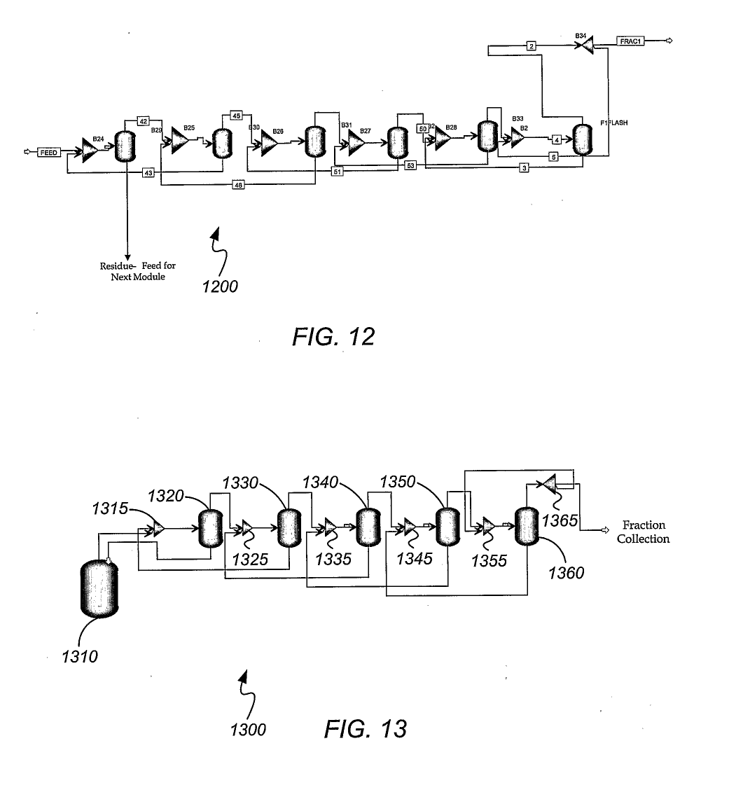

To provide for high-quality separations, multiple trays 1000 can be combined to approximate conventional multi-tray distillation processes. In one such embodiment, illustrated in FIG. 11, six tray modules 1110 are coupled in series within a housing 1120 to form a multi-tray unit 1100, with the condensed vapor fraction collected at the vapor outlet of each tray module serving as the liquid feed stream introduced at the liquid inlet of the subsequent tray module in the series and the liquid phase collected at the liquid outlet of each tray module (after the first tray module) being recirculated for introduction into the preceding tray module, to approximate a six tray distillation 1200 (as illustrated in FIG. 12), producing a single residue fraction and a single, high-quality vapor fraction that can be collected in collection vials 1130, 1140 (via fluid conduits (not shown)). Optionally, multiple multi-tray units can be combined (e.g., in series) to form a complete, automated continuous fractionation system capable of collecting a plurality of high-quality fractions. Thus, for example, one such system could include eight 6-tray units 1100 coupled in series, such that the liquid phase produced in the first separation in each unit (instead of being collected in vial 1130) serves as the liquid feed stream for a subsequent multi-tray unit, to yield a single, high-quality “distillate” fraction from each unit and a single heavy residue fraction from the final multi-tray unit.

In embodiments configured to perform batch separation processes, one or more of the flash separation devices described above, optionally in combination with an appropriate number of micropumps, mixers, flow splitters, etc., as also discussed above, are coupled in series to a batch fluid source, the temperatures at each separation device are ramped over the course of the separation, and one or more vapor/condensate fractions are collected. In one such embodiment, illustrated in FIG. 13, a system 1300 includes a batch fluid source 1310, such as a stirred, heated vessel, five microscale flash separation devices 1320, 1330, 1340, 1350, 1360, five liquid mixers 1315, 1325, 1335, 1345, 1355, and a flow splitter 1365. In operation, a batch quantity of a crude fluid mixture to be separated is charged to source vessel 1310. The mixture is pumped from vessel 1310 into first separation device 1320 via mixer/micropump 1315. The operating temperature of first separation device 1320 is gradually ramped over the course of the separation, such that increasingly higher-boiling fractions are collected at the vapor outlet of device 1320. The vapor phase produced in device 1320 is transported to second separation device 1330 via mixer/micropump 1325, while the liquid residue is returned to source vessel 1310. The operating temperature of second separation device 1330 (and each subsequent separation device 1340, 1350 and 1360) is gradually ramped at approximately the same rate as first separation device 1320, with each separation occurring at a lower temperature than the preceding separations. In general, the rate of temperature ramping will be limited by the maximum flowrate achievable in the microfluidic separation devices, as well as by the sample volume to be separated. The liquid residue produced at each separation device 1330, 1340, 1350, 1360 is recirculated to the preceding device (1320, 1330, 1340, 1350, respectively) via the corresponding mixer (1315, 1325, 1335, 1345). The vapor fraction produced in each of separation devices 1330, 1340 and 1350 is transported to the subsequent separation device in the series via the corresponding mixer 1325, 1335, 1345, while the vapor phase produced in fifth separation device 1360 is transported to flow splitter 1365, where a portion is recirculated to separation device 1360 via mixer 1355. The remaining portion of the vapor phase produced at separation device 1360 is collected as a series of fractions, each corresponding to a given set of temperatures of the series of separation devices.

Optionally, the system can include a stream selection valve downstream from flow splitter 1365, which may facilitate automation of the collection procedure into multiple fraction vials. Also optionally, the system can also include one or more additional flow splitters configured to allow collection of one or more additional fractions at intermediate locations in the flow path (e.g., splitter 945 as shown in FIG. 9), although removing multiple fractions may result in lower-quality fractions in systems having the same number of separation stages.

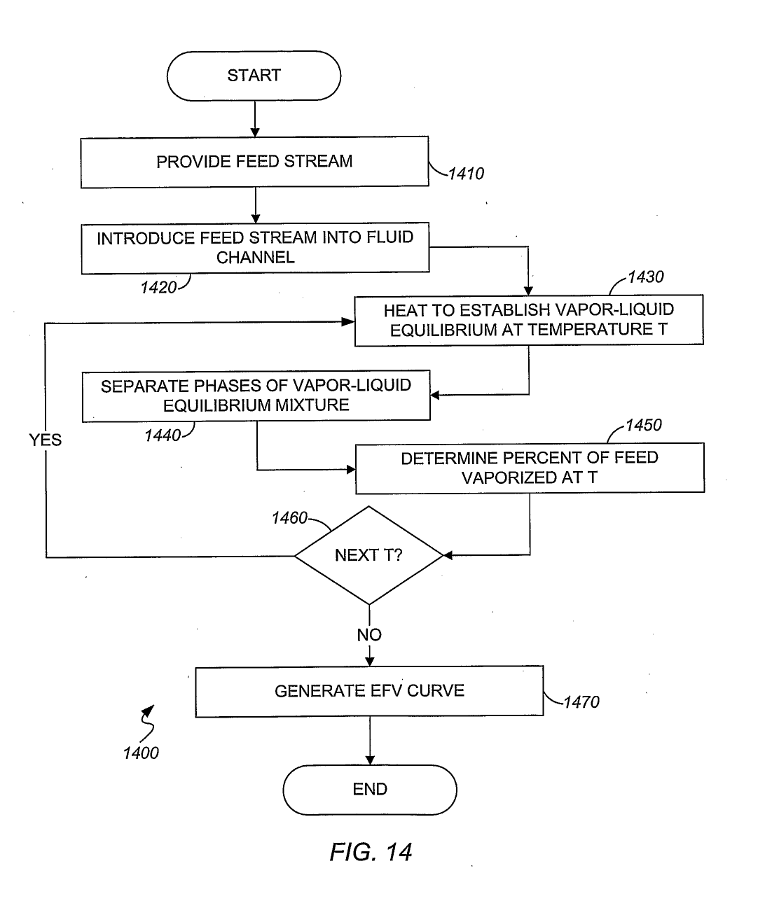

In another aspect of the present invention, a single-stage system such as system 600 (FIG. 6) can be used to characterize complex mixtures. A procedure 1400 using one such system to obtain an equilibrium flash vaporization curve is illustrated in FIG. 14. An EFV curve can be used to characterize any multicomponent liquid mixture, and can in particular be used to obtain a true boiling point (TBP) curve for petroleum mixtures such as crude oil or crude oil fractions. A TBP curve describes the percent of feed vaporized as a function of the saturated vapor temperature for an infinite-plate batch distillation. TBP curves are known to provide a useful means to characterize a crude oil feedstock or fraction, since such curves directly describe the composition of the complex liquid mixture.

An EFV curve describes the percent of feed vaporized as a function of flash temperature at a given pressure for a continuous flow of a feed mixture in a steady-state process (i.e., with continuous removal of the separated vapor and liquid streams). According to method 1400, an EFV curve can be obtained by operating a single flash separation device (e.g., system 600), typically at a series of increasing temperatures, while recording the percent of feed vaporized at each temperature. The feed is introduced as a continuous flow, pumped over time at a controlled rate, and the vapor (or “distillate”) and/or the liquid (“residue”) is collected over the same period of time. By weighing the distillate and/or residue (and subtracting the residue weight from the amount of total input feed) after a known elapsed time, the percent of feed vaporized at that flash temperature is determined. By running this test on a single feed and ramping the operating temperature of the device in discrete steps, the EFV curve can be obtained as follows.

Thus, to begin the analytical method, a feed stream is provided that contains the mixture to be analyzed (step 1410). The feed stream is introduced into the microscale fluid channel of the separation device as discussed above (step 1420). The feed stream is typically a multi-component mixture that is in the liquid phase (or a gas-liquid mixture) under the conditions under which it is introduced into the device. The feed stream is heated to establish a vapor-liquid equilibrium at a first temperature, Tᵢ (step 1430). After the system has come to thermal equilibrium at Tᵢ, the equilibrium mixture is separated using a capillary network to isolate the liquid phase from the vapor phase as discussed above (step 1440). The vapor phase is quantified to determine the percent of the feed stream vaporized at Tᵢ (step 1450). In some embodiments, the vapor phase is condensed and collected (e.g., in a cooled vial) over a given time interval and the amount collected over the time interval is determined by, e.g., weighing. Alternatively, the liquid phase can be collected, the amount determined (e.g., by weighing), and subtracted from the total amount of the input feed stream introduced into the device over the time interval. Alternatively, the vapor phase can be quantified without collecting any material (e.g., using in-line mass flow meters to measure the rate of production of the vapor phase directly and/or the rate of production of the liquid phase, which is then subtracted from the input feed rate to obtain the rate of production of the vapor phase). The feed stream is heated to the next Tᵢ (the YES branch of step 1460) and the separation and quantification steps 1440 and 1450 are repeated, until the final Tᵢ is reached (the NO branch of step 1460). The values for percentage of feed vaporized at each Tᵢ are then used to generate the equilibrium flash vaporization curve (step 1470), which can be used to generate a TBP curve using published empirical correlations or commercially available algorithms (e.g., Aspen HYSYS, available from AspenTech).

For some applications, performing method 1400 at a single temperature may be sufficient to characterize a fluid mixture—for example, for two component systems such as some distilled spirits. Typically, the number of different temperatures in a particular application (and the particular temperatures at which percentage vaporized values are determined) may be selected based on the number of components known or expected to be in the mixture under analysis.

The method 1400 can offer a number of advantages over existing techniques for calculating TBP curves of petroleum mixtures (e.g., ASTM D86 distillation, ASTM D2892/5236 distillation, GC “Simulated Distillation” methods). In some embodiments, the device has residence times of approximately 1 msec for all species, which reduces the risk of thermal cracking at elevated temperatures. Total sample size required is approximately 10 ml or less, and a full TBP curve can be obtained in 1 hour or less. The device can be operated using only electricity (and the feed stream) as inputs. This, in addition to the small size of the microfluidic separation devices, means that the system used to perform the method can be truly portable, malting it possible to rapidly characterize crude oil feedstocks in remote locations (e.g., at well pumps or offshore locations).

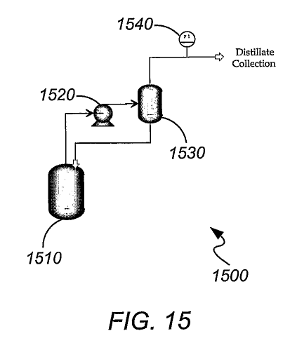

A system 1500 suitable for implementing such processes for characterizing fluid mixtures is illustrated in FIG. 15. As shown, system 1500 includes a vessel 1510 that can be charged with a fluid mixture to be characterized. A pump 1520 delivers a continuous stream of the fluid mixture from vessel 1510 to an inlet of a temperature-controlled flash separation device 1530. The operating temperature of device 1530 is gradually ramped (e.g., according to a predetermined temperature profile) under the control of, e.g., a computer-controlled temperature controller (not shown). The residual liquid phase separated at each temperature is returned to vessel 1510. The vapor phase is condensed and quantified—for example, by collecting the condensate and determining the cumulative weight or volume that is collected at each temperature. Alternatively, the vapor phase separated at each temperature can be quantified without collecting fractions—for example, using an in-line mass flow meter 1540. Optionally, rather than quantifying the vapor phase after a single separation, the vapor phase can be transported to and further separated in one or more additional separation devices, as described in the above embodiments. The cumulative weight/volume of vapor separated at each temperature can be used to produce a curve, similar to the EFV curve discussed above, that approximates a curve generated using the well-known ASTM D86 procedure for batch distillation of petroleum products at atmospheric pressure. The resulting ASTM D86 curve provides a quantitative representation of the boiling range characteristics of the fluid mixture, and in particular describes the percent of feed vaporized as a function of the saturated vapor temperature above the boiling liquid for a one-plate batch distillation. If desired, the D86 curve can be converted to other curves (EFV, TBP) using known conversion techniques.

### EXAMPLES

### Example 1

### Single-Flash, Model Binary Mixture

A binary mixture of approximately 50/50 w/w (61/39 mole/mole) pentane/octane is fed continuously via a syringe pump at a feed rate of 0.5 mL/min. to the inlet of a microfluidic separation device containing 48,000 20-micron diameter phase-separation capillary channels (e.g., device 500, FIGS. 5A-5C). The entire device is heated to 80° C. via a temperature controller. The condensed vapor and the liquid residue outlets are collected into separate vials for at least 5 minutes. The outlet streams are analyzed by gas chromatography. The condensed vapor contains 81.5 mole % pentane and the liquid residue contains 30.4 mole % pentane.

### Example 2

### Single-Flash, Crude Oil

A crude oil is fed continuously to the inlet of a microfluidic separation device (e.g., device 500, FIGS. 5A-5C, 48,000 20-micron diameter phase-separation capillary channels) via a syringe pump, through an in-line 10-micron stainless steel filter at a feed rate of 0.25 mL/min. The entire device is heated to 200° C. via a temperature controller. The condensed vapor and the liquid residue outlets are collected into separate vials at atmospheric pressure for at least 10 minutes. The outlet streams are analyzed by gas chromatography (according to the method of ASTM D2887), and are found to have true-boiling point (TBP) curves as given below.

| | True Boiling Point | True Boiling Point |
|---|---|---|
| Weight % | (TBP) of Condensed Vapor | (TBP) of Liquid Residue |
| Distilled | (Degrees C.) | (Degrees C.) |
| 0 | −43.6 | 71.4 |
| 5 | 1.0 | 177.8 |
| 10 | 27.4 | 224.4 |
| 30 | 85.7 | 303.3 |
| 50 | 125.5 | 369.0 |
| 70 | 164.3 | 448.9 |
| 90 | 233.8 | 596.1 |
| 95 | 263.3 | 650.1 |
| 100 | 309.3 | 690.8 |

### Example 3

### Multiple-Flash, Model Binary Mixture

Three microfluidic devices (e.g., device 500, FIGS. 5A-5C, 48,000 20-micron diameter phase-separation capillary channels) are fluidically-connected using 1/16″ Valco nuts and ferrules and 1/16″ outer diameter Teflon tubing such that the vapor outlet from the first device (operating at 70° C.) is the feed for the second device (operating at 50° C.) and the liquid residue outlet from the first device is the feed for the third device (operating at 80° C.).

A binary mixture of ˜50/50 w/w (61/39 mole/mole) pentane/octane is fed continuously to the inlet of the first device via a syringe pump at a feed rate of 0.5 mL/min. Four fractions are collected simultaneously from the outlets of the second and third devices for at least 5 minutes and are analyzed by gas chromatography as described above. The condensed vapor and the liquid residue from the 50° C. device are found to contain 94.5 mole % and 62.5 mole % pentane, respectively, and the condensed vapor and the liquid residue from the 80° C. device are found to contain 71.7 mole % and 29.0 mole % pentane, respectively.

### Example 4

### Multiple-Flash, Crude Oil

Three microfluidic devices (e.g., device 500, FIGS. 5A-5C, 48,000 20-micron diameter phase-separation capillary channels) are fluidically-connected using 1/16″ Valco nuts and ferrules and 1/16″ outer diameter Teflon tubing such that the vapor outlet from the first device (operating at 150° C.) is the feed for the second device (operating at 75° C.) and the liquid residue outlet from the first device is the feed for the third device (operating at 220° C.).

A crude oil is fed continuously to the inlet of the first device via a syringe pump and an in-line 10-micron stainless steel filter at a feed rate of 0.25 mL/min. Three fractions are collected simultaneously: first, the condensed vapor from the second (coolest) device; second, the liquid residue from the third (hottest) device; and third, a mixture of the condensed vapor from the third device and the liquid residue from the second device. All three fractions are collected simultaneously into vented collection vials for at least 10 minutes. The 3 outlet streams are analyzed by gas chromatography (according to the method of ASTM D2887), and are found to have true-boiling point (TBP) curves as given below.

| | True Boiling | | True Boiling | | True Boiling |
|---|---|---|---|---|---|
| Weight % | Point, Fraction 1 | Weight % | Point, Fraction 2 | Weight % | Point, Fraction 3 |
| Distilled | (Degrees C.) | Distilled | (Degrees C.) | Distilled | (Degrees C.) |
| 38 | 36 | 7.5 | 36 | 0 | 46.6 |
| 40 | 48.5 | 10 | 52.5 | 5 | 174.2 |
| 50 | 60 | 20 | 82 | 10 | 208.4 |
| 60 | 68 | 30 | 101 | 20 | 249.8 |
| 70 | 83 | 40 | 117.5 | 30 | 283 |
| 80 | 97 | 50 | 139.5 | 40 | 313.6 |
| 90 | 111.5 | 60 | 165.5 | 50 | 345.4 |
| 95 | 126 | 70 | 200 | 60 | 382.7 |
| 100 | 173 | 80 | 254.5 | 70 | 423.5 |
| | | 90 | 346 | 80 | 474.3 |
| | | 95 | 420.5 | 90 | 546.9 |
| | | 100 | 524 | 95 | 608.1 |
| | | | | 100 | 717.4 |

### Example 5

### Portable Microfluidic True-Boiling Point (TBP) Device

Crude oil to be analyzed is fed continuously to a microfluidic device (e.g., device 500, FIGS. 5A-5C, 225,000 10-micron diameter capillary channels) using a syringe pump at 0.25 mL/min through a 10 micron in-line filter. The microfluidic device is temperature controlled via a closed-loop controller. The device is initially set to 100° C., allowed to equilibrate for at least 2 minutes, and the condensed vapor is collected and weighed for at least 5 minutes. This procedure is repeated at device temperatures of 125, 175, 200 and 225° C. The resulting “wt % of feed vaporized” at each operating temperature is used to construct an equilibrium flash vaporization (EFV) curve. The EFV data was converted to True Boiling Point (TBP) data via a commercially-available software algorithm (available in Aspen HYSYS, AspenTech, Inc.). The following table shows the predicted TBP profile for the crude oil versus the TBP profile obtained using ASTM methods D2892 and D5236.

| PREDICTED FROM | | DATA FROM ASTM | |
|---|---|---|---|
| MICROFLUIDIC DEVICE | | D2892/5236 METHODS | |
| Weight % | True Boiling Point | Weight % | True Boiling Point |
| Distilled | (Degrees C.) | Distilled | (Degrees C.) |
| 0 | −69.99 | 3.55 | 15 |
| 5 | 39.05 | 17.45 | 95 |
| 10 | 80.01 | 32.70 | 149 |
| 15 | 100.97 | 39.30 | 175 |
| 20 | 114.66 | 50.10 | 232 |
| 30 | 153.87 | 70.65 | 342 |
| 40 | 193.27 | 74.75 | 369 |
| 50 | 235.72 | 90.00 | 509 |
| 60 | 282.49 | 92.75 | 550 |
| 70 | 333.80 | | |
| 80 | 401.16 | | |
| 85 | 444.49 | | |
| 90 | 516.75 | | |
| 95 | 679.79 | | |
| 100 | 917.58 | | |

A number of embodiments of the invention have been described. Nevertheless, it will be understood that various modifications may be made without departing from the spirit and scope of the invention. For example, while the methods, apparatus and systems of the invention have been described in the context of separating and analyzing crude oils and/or crude oil fractions, the same or analogous methods, apparatus and systems can be used to separate and/or analyze other multi-component mixtures, such as agricultural products (such as plant oils, distillates and extracts), animal oils, wines and spirits, flavors, fragrances, and the like. Accordingly, other embodiments are within the scope of the following claims.

1. A microfluidic separation device, comprising: an inlet port for receiving a fluid feed stream; a microscale fluid flow channel in fluid communication with the fluid inlet port; a phase equilibrium control region located along at least a portion of the fluid flow channel for providing a thermal equilibrium in the at least a portion of the fluid flow channel; a capillary network in the phase equilibrium control region, the capillary network being in fluid communication with the fluid flow channel and comprising a plurality of capillary channels extending outwardly from an axis of the fluid flow channel; a first outlet port in indirect fluid communication with the fluid flow channel through the capillary network; and a second outlet port in direct fluid communication with the fluid flow channel, the fluid flow channel extending from the fluid inlet port to the second fluid outlet port.

2. The device of claim 1, wherein: the capillary channels of the capillary network are formed in a side surface of the fluid flow channel in the temperature control region.

3. The device of claim 1, wherein: the capillary channels of the capillary network are formed in a top or bottom surface of the fluid flow channel in the temperature control region.

4. The device of claim 1, wherein: the capillary network includes at least 50 capillary channels.

5. The device of claim 4, wherein: the capillary network includes at least 100,000 capillary channels.

6. The device of claim 1, wherein: the fluid flow channel and the capillary network are formed from the same material.

7. A microfluidic separation system, comprising: a plurality of devices according to claim 1; fluid conduits defining a fluid flow path between the plurality of devices, the fluid conduits connecting the plurality of devices in fluid communication to define a series of devices such that the second outlet port of a first device in the series is in fluid communication with the inlet port of a second device in the series, the first device being configured to operate at thermal equilibrium at a first temperature and pressure, each subsequent device in the series being configured to operate at thermal equilibrium at a temperature and/or pressure different from the temperature and/or pressure of a preceding device in the series.

8. The system of claim 7, wherein: each subsequent device in the series is configured to operate at thermal equilibrium at a temperature higher than the temperature and/or a pressure lower than the pressure of the preceding device in the series.

9. The system of claim 7, wherein: each subsequent device in the series is configured to operate at thermal equilibrium at a temperature lower than the temperature and/or a pressure higher than the pressure of the preceding device in the series.

10. The system of claim 7, wherein: the first outlet port of the second device in the series is in fluid communication with the inlet port of the first device in the series to provide for recirculation of at least a portion of a fraction produced in the second device to a separation being performed in the first device.

11. The system of claim 7, wherein: the second outlet port of the second device is in fluid communication with the inlet port of a third device in the series; and the first outlet port of the third device is in fluid communication with the inlet port of the second device to provide for recirculation of at least a portion of a fraction produced in the third device to a separation being performed in the second device.

12. The system of claim 10, further comprising: one or more liquid mixers located in the flow path between the first and second devices in the series, the liquid mixers being operable to mix the at least a portion of the fraction produced in the second device with the fluid feed stream for the first device.

13. The system of claim 7, wherein: the system is configured as an arrangement of modular units, each of the modular units containing one of the plurality of devices, one of the liquid mixers optionally being associated with the one of the plurality of devices in each of the modular units.

14. The system of claim 13, wherein: the modular units are arranged to define an arrangement comprising a plurality of unit series, each unit series comprising a plurality of separation devices coupled in series, a first one of the plurality of unit series being configured to produce a first vapor fraction and a first liquid fraction, a second one of the plurality of unit series being configured to receive the single liquid fraction produced by the first unit series as an input fluid stream and to produce a second vapor fraction and second liquid fraction.

15. The system of claim 14, wherein: each of the unit series after the first unit series is configured to operate at a higher temperature and/or a lower pressure than the preceding unit series in the arrangement.

16. The system of claim 14, wherein: each of the unit series after the first unit series is configured to operate at a lower temperature and/or a higher pressure than the preceding unit series in the arrangement.

17. The system of claim 7, further comprising: a source vessel for providing a fluid mixture to be separated, the source vessel being in fluid communication with the inlet port of a first one of the plurality of devices through the fluid conduits.

18. A microfluidic separation system, comprising: a plurality of separation devices, each of the separation devices including an inlet port for receiving a fluid feed stream, a microscale fluid flow channel in fluid communication with the fluid inlet port, a phase equilibrium control region located along at least a portion of the fluid flow channel, a capillary network in the phase equilibrium control region, a first outlet port in indirect fluid communication with the fluid flow channel through the capillary network, and a second outlet port in direct fluid communication with the fluid flow channel, the capillary network being in fluid communication with the fluid flow channel and comprising a plurality of capillary channels extending outwardly from an axis of the fluid flow channel, the fluid flow channel extending from the fluid inlet port to the second fluid outlet port; fluid conduits defining a flow path between the plurality of separation devices, the fluid conduits connecting the plurality of separation devices in fluid communication to define a series of devices such that the second outlet port of a first device in the series is in fluid communication with the inlet port of a second device in the series and the second outlet port of the second device in the series is in fluid communication with the inlet port of a third device in the series; a first liquid mixer located in the flow path between the first and second devices, the first liquid mixer being in fluid communication with the first outlet port of the second device and being operable to mix at least a portion of a liquid fraction produced in the second device with the fluid feed stream for the first device; and a second liquid mixer located in the flow path between the second and third devices, the second liquid mixer being in fluid communication with the first outlet port of the third device and being operable to mix at least a portion of a liquid fraction produced in the third device with the fluid feed stream for the second device.

19-27. (canceled)

28. A method for separating components of a fluid mixture, the method comprising: providing a feed stream containing a fluid mixture, the fluid mixture including a plurality of components; introducing the feed stream into a first microscale fluid flow channel; exposing at least a portion of the first fluid flow channel to first temperature and pressure conditions to establish a thermodynamic equilibrium between a first vapor phase comprising a first component of the fluid mixture and a first liquid phase comprising a second component of the fluid mixture; and separating the first vapor phase and the first liquid phase at the first temperature and pressure conditions by driving the first liquid phase through a capillary network comprising a plurality of capillary channels extending outwardly from an axis of the first fluid flow channel to obtain a first vapor fraction comprising the first component and a first liquid fraction comprising the second component.

29-39. (canceled)

40. A method for analyzing a fluid mixture, the method comprising: providing a feed stream containing a fluid mixture; introducing the feed stream into a microscale fluid flow channel; exposing at least a portion of the fluid flow channel to first temperature and pressure conditions over a first time interval to establish a vapor-liquid equilibrium mixture; separating the vapor-liquid equilibrium mixture at the first temperature and pressure conditions by driving a liquid phase of the vapor-liquid equilibrium mixture through a capillary network comprising a plurality of capillary channels extending outwardly from an axis of the first fluid flow channel to obtain a liquid fraction and a first vapor fraction; determining a percentage of the feed stream vaporized at the first temperature and pressure conditions; and characterizing the fluid mixture based at least in part on the determined percentage of the feed stream vaporized at the first temperature and pressure conditions.

41. The method of claim 40, further comprising: repeating the exposing, separating and determining on one or more second portions of the feed stream over one or more second time intervals to determine a percentage of the feed stream vaporized at each of one or more second temperature and pressure conditions based on amounts of one or more second vapor fractions obtained from the separating at each of the one or more second temperature and pressure conditions; determining a percentage of the feed stream vaporized at the second temperature and pressure conditions; and wherein characterizing the fluid mixture includes characterizing the fluid mixture based at least in part on the determined percentage of the feed stream vaporized at the first and second temperature and pressure conditions.

42. The method of claim 40, wherein: the characterizing includes generating an Equilibrium Flash Vaporization (EFV) curve for the fluid mixture, the EFV curve describing a percentage of the feed stream vaporized as a function of flash temperature.

43. The method of claim 42, wherein: the characterizing includes using the EFV curve to generate a True Boiling Point (TBP) curve for the fluid mixture.

44. The method of claim 40, wherein: providing a feed stream comprises providing a feed stream from a batch source of the fluid mixture.

45. The method of claim 40, wherein: the characterizing includes generating an ASTM D86 curve for the fluid mixture.

46. A system for analyzing a liquid mixture, the system comprising: a fluid inlet port for receiving a fluid feed stream, the fluid feed stream comprising a fluid mixture; a microscale fluid flow channel in fluid communication with the fluid inlet port; a temperature controller configured to provide a temperature-controlled environment along at least a portion of the fluid flow channel; a capillary network in fluid communication with the fluid flow channel, the capillary network comprising a plurality of capillary channels extending outwardly from an axis of the fluid flow channel; a first outlet port in indirect fluid communication with the fluid flow channel through the capillary network; and a second outlet port in direct fluid communication with the fluid flow channel, the fluid flow channel extending from the fluid inlet port to the second fluid outlet port a sensor coupled to the first outlet port or the second outlet port, the sensor being operable to determine an amount of one or more vapor or liquid components obtained at the first or second outlet port over one or more specified time intervals; and a processor coupled to the sensor, the processor being operable to receive from the sensor signals representing the determined amounts of the vapor or liquid components, and to generate information characterizing the fluid mixture based on the determined amounts.

47-58. (canceled)
